(19) United States
(12) Patent Application Publication
(10) Pub. No.: US 2003/0193692 A1
(43) Pub. Date: Oct. 16, 2003

(54) Color image transmitting apparatus

(75) Inventor: Teruki Matsuyama, Ikoma-gun (JP)

Correspondence Address: Dike, Bronstein, Roberts & Cushman, Intellectual Property Practice Group, Edwards & Angell, LLP, 130 Water Street, Boston, MA, 02109, US

(73) Assignee: Sharp Kabushiki Kaisha

(21) Appl. No.: 10/410,102

(22) Filed: Apr. 9, 2003

(30) Foreign Application Priority Data
Apr. 10, 2002 (JP) P2002-108123

(51) Int. Cl. H04N 1/40; G06K 15/00; H04N 1/32; H04N 1/46; H04N 1/41

(52) U.S. Cl. 358/2.1; 358/500; 358/426.02; 358/426.12; 358/434; 358/468

(57) ABSTRACT

The facsimile apparatus comprises a control portion for performing control of the whole of the facsimile apparatus, an operation portion, a display portion, a RAM for image memory, a ROM for storing programs and data, a communication control portion for performing connection to the other facsimile, a JPEG coding portion for coding a transmitting color original document, a monochrome coding portion for coding the transmitting monochrome original document, and an original document reading portion. The facsimile apparatus converts the color original document to the monochrome original document when transmitting the color original document in monochrome and adds the message indicating that the color original document was transmitted in monochrome to the color original document when the facsimile apparatus tries to transmit the color original document and the other facsimile declares that the other facsimile has only an ability of receiving the color original document in monochrome.

### BACKGROUND OF THE INVENTION

1. Field of the Invention

The present invention relates to a color image transmitting apparatus having a function for transmitting and receiving a color document.

2. Description of the Related Art

A color facsimile apparatus which carries out facsimile transmission and reception of a color document in addition to a monochrome document is put into practical use. The color facsimile apparatus is recommended by ITU-T recommendation T.30 ANNEX E and can transmit and receive color documents.

FIG. 12 is a schematic block diagram of a facsimile apparatus having a function of general color facsimile communication.

The facsimile apparatus comprises a control portion 1001, an operation portion 1002, a display portion 1003, a JPEG (Joint Photographic Experts Group) decoding portion 1004, a monochrome image decoding portion 1005, a RAM (Random Access Memory) 1006, a ROM (ReadOnlyMemory) 1007, a printing portion 1008, a communication control portion 1009, a JPEG coding portion 1011, a monochrome image coding portion 1012 and a original document reading portion 1012.

The control portion 1001 is a portion which controls the whole of the facsimile apparatus and a CPU (Central Processing Unit) is generally used as the control portion. The operation portion 1002 includes a keypad for performing an input of a telephone number and a facsimile transmitting/receiving operation. The display portion 1003 performs displaying the telephone number, a condition of the facsimile apparatus and an operation menu or the like thereon.

The JPEG decoding portion 1004 performs JPEG decoding the color document received from a facsimile apparatus on the other side. The monochrome image decoding portion 1005 performs JPEG decoding the monochrome document received from the facsimile apparatus on the other side. MH (Modified Huffman), MR (Modified Read), MMR (Modified Modified Read), JBIG (Joint Bi-level Image Experts Group) or the like is used as a decoding method of the monochrome document. The RAM 1006 is mainly used by the control portion 1001 and is used as working memory and for saving a transmitting/receiving document. The ROM 1007 is mainly used by the control portion 1001 and a program and data for controlling the facsimile apparatus are stored therein.

The printing portion 1008 performs processing of printing the monochrome document or the color document received and decoded from the facsimile apparatus on the other side on a sheet. The communication control portion 1009 controls connection to the facsimile apparatus on the other side via a telephone line 1010 and performs processing of transmitting/receiving image data to/from the facsimile apparatus on the other side. The telephone line 1010 is a general public line for connecting to the facsimile apparatus on the other side.

The JPEG coding portion 1011 codes a color original document read from a original document reading portion 1014 by using a method of JPEG coding method, for the purpose of transmitting the color original document to the facsimile apparatus on the other side.

The monochrome image coding portion 1012 codes a monochrome original document read from the original document reading portion 1014 by using MH, MR, MMR or JBIG coding method, for the purpose of transmitting the monochrome original document to the facsimile apparatus on the other side. The original document reading portion 1014 performs reading the monochrome original document or the color original document, for the purpose of transmitting the monochrome original document or the color original document to the facsimile apparatus on the other side.

When the original document read by the original document reading portion 1014 is a color original document, the original document is coded by the JPEG coding portion 1011. When the original document read by the original document reading portion 1014 is a monochrome original document, the original document is the monochrome image coding portion 1012. Whether the original document is transmitted in color or monochrome is designated by a user via the operation portion 1002. The coded image data are transmitted to the facsimile apparatus on the other side from the communication control portion 1009 via the telephone line 1010.

On the other hand, as to the image data received by the communication control portion 1009 via the telephone line 1010 from the facsimile apparatus on the other side, when the received image data are color image data, the received image data are transmitted to the JPEG decoding portion 1004, whereas when the received image data are monochrome image data, the received image data are transmitted to the monochrome decoding portion 1005, and thereafter, the transmitted data are decoded. The decoded image is printed by the printing portion 1008.

In the color facsimile apparatus, whether the facsimile apparatus on the receiving side can receive the color original document is indicated by a bit 68 (corresponding to JPEG coding) and a bit 69 (corresponding to full color mode) of a DIS (Digital Identification Signal) transmitted from the receiving side to the transmitting side at the procedure of connecting to the other facsimile apparatus. When the color original document can be received, the DIS with the set bits 68 and 69 is transmitted from the facsimile apparatus on the receiving side and the facsimile apparatus on the transmitting side refers to the DIS and transmits the color original document in color on condition that the bits 68 and 69 of the DIS are set, but transmits the color original document in monochrome on condition that the bits 68 and 69 of the DIS are not set.

In the color facsimile apparatus, there is a case where reception of the color original document temporarily becomes impossible because of any factor such as absence of a color ink, a little available capacity of the memory or the like. When the facsimile apparatus on the receiving side temporarily cannot receive the color original document, the facsimile apparatus sets the bit 68 and the bit 69 of the DIS to off state and transmits the DIS to the facsimile apparatus on the transmitting side. The facsimile apparatus on the transmitting side refers to the bit 68 and the bit 69 of the DIS and judges that the facsimile apparatus on the receiving side has no ability of receiving the color original document and transmits the color original document in monochrome even in the case of the color original document which is tried to be transmitted in color from the facsimile apparatus on the transmitting side.

There is a problem that when the facsimile apparatus on the receiving side temporarily sets an ability of receiving the color original document to off state with the intention of transmitting the color original document, the color original document is transmitted in monochrome in spite of availability for transmitting the color original document in color, on condition that a factor by which the ability of receiving the color original document is set to off state is removed. Consequently, there is a problem that a user of the facsimile apparatus on the receiving side cannot identify whether the received original document is an original documents to be transmitted in color or an original document to be transmitted in monochrome. In addition, there is a problem that processing of retransmitting the original document in color is not performed after success in transmitting the original document in monochrome once.

The following system is suggested as one of systems which solve the above mentioned problems: in a color facsimile system disclosed in Japanese Unexamined Patent Publication JP-A 11-55532 (1999), the color facsimile system incorporates an identification signal indicated whether image information to be transmitted is color image information or monochrome image information into a NSS (Non-Standard Set-up) and the color facsimile system transmits the image information in monochrome, and thereafter the color facsimile system refers to the identification signal incorporated in the NSS on the receiving side and outputs a print of an identification code and a color notification code and enables polling receiving the color original document to be performed by using the identification code and the color notification code.

However, since the non-standard signal is used for identifying the color original document in the system disclosed in JP-A 11-55532, the system cannot be applied in the case where the color original document is transmitted to a facsimile apparatus other than the color facsimile apparatus disclosed in JP-A 11-55532.

### SUMMARY OF THE INVENTION

It is an object of the invention to provide a color image transmitting apparatus capable of retransmitting the original document in color easily when the original document is transmitted in monochrome according to a mode of an ability of color receiving on the receiving side, in the case of trying to transmit the original document in color.

To solve the above mentioned problems, the invention mainly adopts the following configuration.

The invention provides a color image transmitting apparatus having a color image communication function, comprising:

a communication control portion having a function judging whether an apparatus on other side has an ability of receiving a color image or not;

a monochrome conversion portion for converting the color image to a monochrome image according to judgment of the ability of receiving the color image; and

a monochrome conversion information adding processing portion for adding a message indicating that the color image was transmitted as a monochrome image.

Also, in the invention, it is preferable that the monochrome conversion information adding processing portion has a function for making a cover page with the added message indicating that the color image was transmitted as the monochrome image.

Also, in the invention, it is preferable that the monochrome conversion information adding processing portion has a function for making a transmitting header with the added message indicating that the color image was transmitted as the monochrome image.

In the invention, it is preferable that the transmitting header is provided on each page of the transmitting image.

In the invention, it is preferable that the monochrome conversion information adding processing portion has a function of adding a message indicating that the color image was transmitted in monochrome to the image to be transmitted.

Also, in the invention, it is preferable that the color image transmitting apparatus comprises a storage portion for storing temporarily the color image when the color image was transmitted as the monochrome image.

Also, in the invention, it is preferable that the message includes a sub-address for prompting the apparatus on the other side to re-receive the color image.

In the invention, it is preferable that the message includes a DTMF signal for prompting the apparatus on the other side to re-receive the color image.

In the invention, it is preferable that when there is no request for re-receiving in spite of elapsing of a certain time at a time of storing the color original document in the storage portion, the stored color original document is deleted.

According to the structure of the invention as mentioned above, a receiver can recognize from the cover page and the transmitting header that the original document which the facsimile apparatus on the transmitting side had tried to transmit in color was transmitted in monochrome and also even when the facsimile apparatus on a receiving side receives the original document in monochrome in a condition where the facsimile apparatus on the receiving side cannot temporarily receive the original document in color, a processing of re-receiving the color original document can be performed on the basis of information indicated on the cover page.

According to the invention, information indicating that the original document which the facsimile apparatus on the transmitting side had tried to transmit in color was transmitted in monochrome is added to the cover page and the transmitting header and the information is transmitted and thereby the receiver can recognize that the color original document was transmitted in monochrome and also even when the facsimile apparatus on the receiving side receives the original document in monochrome in a condition where the facsimile apparatus on the receiving side cannot temporarily receive the original document in color, a processing of re-receiving the color original document can be performed on the basis of the information indicated on the cover page.

### BRIEF DESCRIPTION OF THE DRAWINGS

Other and further objects, features, and advantages of the invention will be more explicit from the following detailed description taken with reference to the drawings wherein:

FIG. 1 is a simplified schematic block diagram showing electric configuration of a facsimile apparatus according to an embodiment of the invention;

FIG. 2 is a sequence diagram explaining signals flowing between apparatuses in processing of transmitting the image data performed by the facsimile apparatus according to the embodiment of the invention;

FIG. 3 is a view showing an example of the cover page giving information indicating that the color original document related to the embodiment of the invention was transmitted in monochrome;

FIG. 4 is a view showing an example of a transmitting header in the embodiment of the invention;

FIG. 5 is a view showing an example of transmitting the cover page related to an embodiment of the invention with the original document image;

FIG. 6 is a flowchart showing a facsimile transmitting procedure in the facsimile apparatus according to the embodiment of the invention;

FIG. 7 is a simplified schematic block diagram showing electric configuration of the facsimile apparatus on the receiving side in the embodiment of the invention;

FIG. 8 is a sequence diagram for signals transmitted/received between the facsimile apparatuses on the transmitting side and the receiving side on the occasion of re-receiving the color original document using the sub-address in the embodiment of the invention;

FIG. 9 is a sequence diagram for signals transmitted/received between the facsimile apparatuses on the transmitting side and the receiving side on the occasion of re-receiving the color original document by using the DTMF signal in the embodiment of the invention;

FIG. 10 is a flowchart showing a re-receiving procedure of the facsimile apparatuses on the receiving side in the embodiment of the invention;

FIG. 11 is a flowchart showing a re-transmitting procedure of the facsimile apparatuses on the transmitting side in the embodiment of the invention; and

FIG. 12 is a schematic block diagram showing a prior color facsimile apparatus.

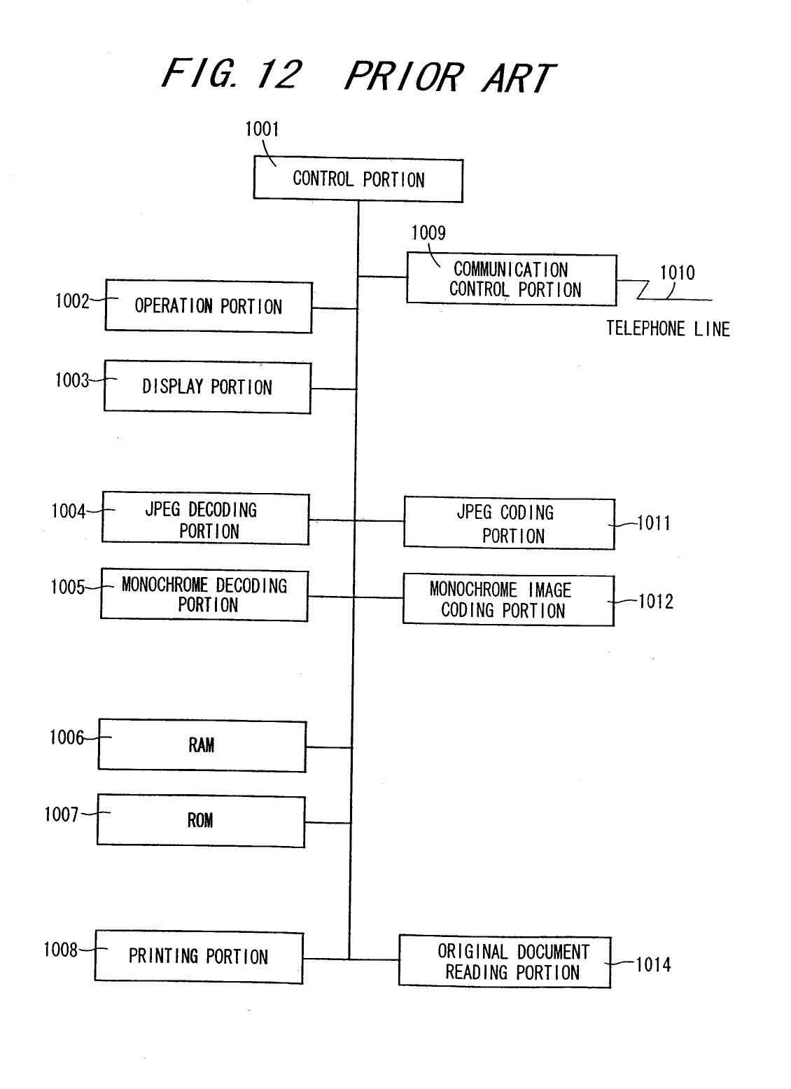

### DETAILED DESCRIPTION OF THE PREFERRED EMBODIMENTS

Now referring to the drawings, preferred embodiments of the invention are described below.

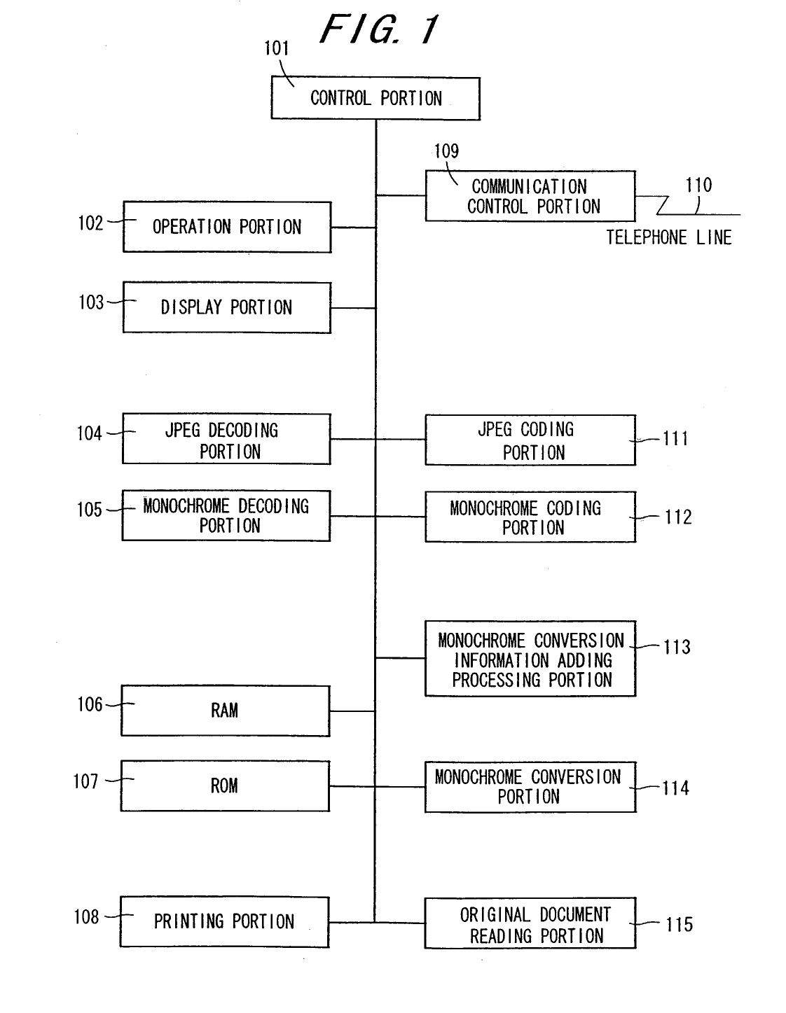

The following description will describe the color image transmitting apparatus according to embodiments of the invention with reference to the accompanying drawings. FIG. 1 is a block diagram showing electric configuration of the color facsimile apparatus according to an embodiment of the invention. In FIG. 1, the facsimile apparatus according to the embodiment comprises a control portion 101, an operation portion 102, a display portion 103, a JPEG (Joint Photographic Experts Group) decoding portion 104, a monochrome decoding portion 105, a RAM (Random Access Memory) 106, a ROM (Read Only Memory) 107, a printing portion 108, a communication control portion 109, a JPEG coding portion 111, a monochrome coding portion 112, a monochrome conversion information adding processing portion 113, a monochrome conversion portion 114, and an original document reading portion 115.

The control portion 101 comprises CPU (Central Processing Unit) and controls operation of the facsimile apparatus. The operation portion 102 is composed of various operation keys, switches and the like. The display portion 103 consists of a liquid crystal screen and the like. A user's operation is accepted via the operation portion 102 and the display portion 103. The original document reading portion 115 is provided with a line sensor such as a CCD (Charge Coupled Device) image sensor or a CIS (Contact Image Sensor) and reads an image of a transmitting original document placed on an original document table or a sheet feeder (not shown.)

The JPEG coding portion 111 performs compression and coding of color image data read by the original document reading portion 115 according to a method of JPEG coding. The JPEG decoding portion 104 performs decompression and decoding of the coded image data. The monochrome coding portion 112 performs compression and coding of image data read by the original document reading portion 115 according to a method of MH (Modified Huffmann), MR (Modified Read), MMR (Modified Modified Read), or JBIG (Joint Bi-level Image Experts Group) coding. The monochrome decoding portion 105 performs decompression and decoding of the monochrome coded image data.

The RAM 106 is memory which is mainly used in the control portion 101 and is used as working memory and for saving the image data. The ROM 107 is mainly used in the control portion 101 and a control program of the facsimile apparatus and data are saved therein. The printing portion 108 prints the image data decoded by the JPEG decoding portion 104 or the monochrome decoding portion 105 on a recording sheet.

On the other hand, the image data coded by the JPEG coding portion 111 or the monochrome coding portion 112 are transmitted to the communication control portion 109. The communication control portion 109 performs a line connection to an external apparatus and performs negotiation processing which recognizes that a transmitting objective apparatus is a facsimile apparatus after connection of the line and also recognizes a communication ability such as a coding ability and a color facsimile ability mutually common to the transmitting objective apparatus and determines a method of communication. The communication control portion 109 also performs modulation and demodulation of the signal indicating the image data and performs transmitting/receiving the image data via the telephone line.

The signal, indicating the image data coded by the JPEG coding portion 111 or the monochrome coding portion 112, is modulated by the communication control portion 109 and then is transmitted to the telephone line 110 via the communication control portion 109. Also, the signal, indicating the image data received through the telephone line 110, is demodulated by the communication control portion 109 and then is transmitted to the JPEG decoding portion 104 or the monochrome decoding portion 105 via the communication control portion 109.

The monochrome conversion information adding processing portion 113 performs making a transmitting header and a cover page with information indicating that the color original document was transmitted in monochrome. The monochrome conversion portion 114 performs conversion of the color image data to the monochrome image data.

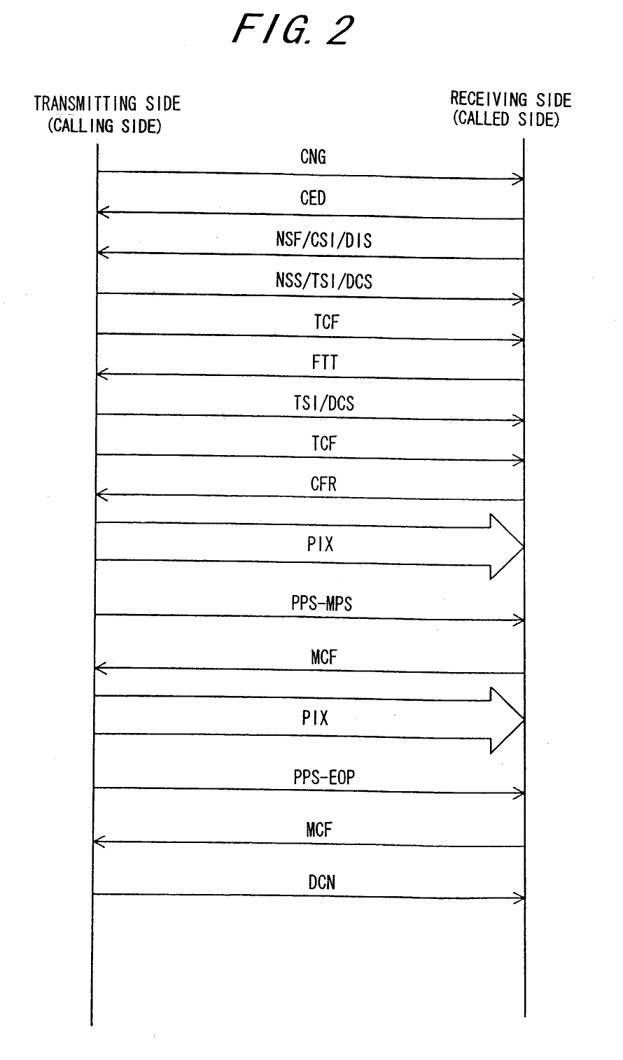

Next, the following will be described with regard to a transmitting processing of the image data according to the embodiment of the invention. FIG. 2 is a sequence diagram explaining signals flowing between apparatuses in processing of transmitting the image data performed by the facsimile apparatus according to the embodiment of the invention. As shown in FIG. 2, at first, the communication control portion 109 establishes connection to the facsimile apparatus on the receiving side (a receiving apparatus).

In other words, as shown in FIG. 2, in the transmitting processing, at first, the communication control portion 109 of the facsimile apparatus on the transmitting side (a transmitting apparatus) transmits a CNG (Calling tone) to the receiving apparatus. The receiving apparatus which received the CNG transmits a CED (Called station identification) to the communication control portion 109 and subsequently transmits an NSF (Non-Standard Facilities), a CSI (Calling Subscriber Identification) and a DIS (Digital Identification Signal) to the communication control portion 109.

When the communication control portion 109 receives these signals, the communication control portion 109 transmits an NSS (Non-Standard Set-up), a TSI (Transmitting Subscriber Identification) and a DCS (Digital Command Signal) to the receiving apparatus. However, there is also a case where the NSF and the NSS are not transmitted. The DCS is created by selecting an ability common to an ability that the facsimile apparatus has, based on the DIS which is a signal indicating an ability of the receiving apparatus. In other words, exchange of an ability between the receiving apparatus and the transmitting apparatus is performed by exchanging the DIS and the DCS, and the coding method, the color facsimile ability and a data signal speed (communication speed) and the like are determined.

As shown in FIG. 2, the communication control portion 109 transmits a TCF (Training Check Facilities) to the receiving apparatus on the occasion of performing training. When the receiving apparatus cannot receive the TCF normally, the receiving apparatus returns an FTT (Failure To Train) to the communication control portion 109. And the communication control portion 109 received the FTT reduces the communication speed and transmits the TSI and the DCS again and then transmits the TCF.

On the other hand, when the receiving apparatus receives the TCF normally, the receiving apparatus returns a CFR (Confirmation to Receive) to the communication control portion 109. The communication control portion 109 thereby confirms success of the training.

Thereafter, the original document reading portion 115 starts to read the original document image. And the monochrome coding portion 112 performs monochrome coding and outputs the original document image to the receiving apparatus via the communication control portion 109. And, after transmission of all the original documents to be transmitted is terminated, the communication control portion 109 disconnects the communication line to the receiving apparatus and terminates communication. That is to say, as shown in FIG. 2, the communication control portion 109 transmits a PIX which is a signal corresponding to the image data coded in monochrome to the receiving apparatus.

In addition, in the processing shown in FIG. 2, the communication control portion 109 is supposed to transmit a PPS-MPS (Partial Page Signal-Multi-Page Signal) after transmitting the PIX. Correspondingly, the receiving apparatus is set so that the receiving apparatus returns a MCF (Message Confirmation) and prompts the transmitting apparatus to transmit the image data of the next page (second page). And after transmission of all the image data is terminated, the communication control portion 109 transmits a PPS-EOP (Partial Page Signal-End Of Procedure) to the receiving apparatus. The receiving apparatus thereby confirms receiving all the image data and returns the MCF to the communication control portion 109. Thereafter, the communication control portion 109 transmits a DCN (Disconnect) to the receiving apparatus and terminates the communication.

When the color original document is transmitted by the facsimile apparatus according to the embodiment of the invention, at first, the user sets the original document on the original document reading portion 115 and then performs color transmitting setting by using the operation portion 102 and dials a phone number of the facsimile apparatus on the other side for communication. The communication control portion 109 tries to perform connection to the facsimile apparatus on the other side.

At that time, the DIS (Digital Identification Signal) indicating a receiving ability is transmitted from the facsimile apparatus on the receiving side. The facsimile apparatus on the transmitting side refers to the bits 68 and 69 of the DIS and checks whether or not the facsimile apparatus on the receiving side has an ability of receiving the original document in color. When the bits 68 and 69 are set and the facsimile apparatus on the transmitting side judges that the facsimile apparatus on the receiving side has the ability of receiving the original document in color, the color original document is read by the original document reading portion 115 and image data of the color original document are JPEG-coded by the JPEG coding portion 104. Thereafter, the signal indicating the JPEG coded color image data is modulated by the communication control portion 109 and then transmission of the color image data is performed from the communication control portion 109 to the facsimile apparatus on the receiving side via the telephone line 110.

When the bits 68 and 69 of the DIS received from the facsimile apparatus on the receiving side are not set, it is judged that the facsimile apparatus on the receiving side has no ability of receiving the color original document in color. Therefore, it is required that the facsimile apparatus on the transmitting side should transmit the color original document in monochrome. In this case, transmission of the cover page indicating that the color original document was transmitted in monochrome is performed. The cover page is made by the monochrome conversion information adding processing portion 113.

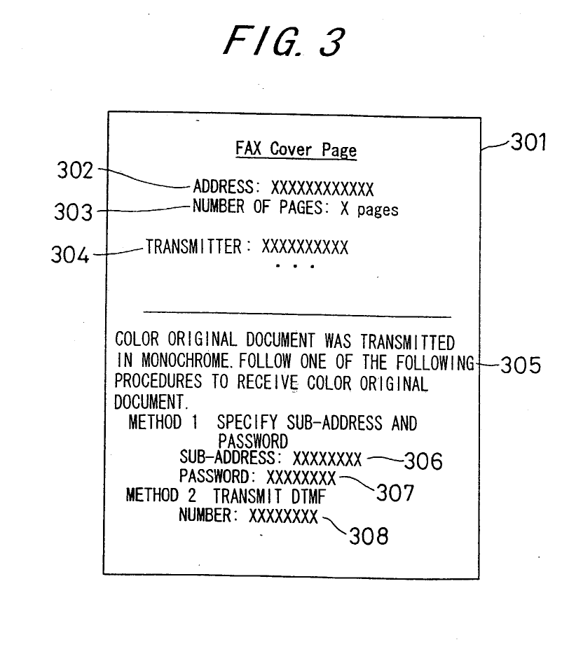

FIG. 3 is a view showing an example of the cover page indicating that the color original document related to the embodiment of the invention was transmitted in monochrome. The cover page 301 includes information about an address 302, a number of pages 303, a transmitter 304 and the like. The cover page 301 also includes information about a message 305 indicating that the color original document was transmitted in monochrome and for prompting the receiver to re-receive the color original document, a sub-address 306, a password 307 and a DTMF (Dual Tone Multi Frequency) number 308.

The sub-address 306 and the password 307 are specified as SEP (Selecting Polling) and PWD (Password), respectively, of facsimile procedure signals so that the facsimile apparatus on the receiving side can re-receive the color image data associated with the sub-address 306 and the password 307. When the facsimile apparatus on the receiving side does not have a function for specifying the sub-address and the password, the DTMF number 308 is used for enabling the facsimile apparatus on the receiving side to re-receive the color image data by using a DTMF signal. The processing of re-receiving the color image data is mentioned later.

The cover page made by the monochrome conversion information adding processing portion 113 is monochrome-coded by the monochrome coding portion 112 and is transmitted from the communication control portion 109 to the facsimile apparatus on the receiving side.

On the other hand, the color image read by the original document reading portion 115 is JPEG-coded by the JPEG coding portion 104 and then is temporarily stored in the RAM 106. The sub-address, the password and the DTMF number described on the cover page are assigned to the color image stored in the RAM 106. At the same time, the color image read by the original document reading portion 115 is converted to the monochrome image by the monochrome conversion portion 114 and is monochrome-coded by the monochrome coding portion 112. At that time, the message indicating that the color original document was converted to the monochrome original document is added to the transmitting header. The transmitting header is made by the monochrome conversion information adding processing portion 113.

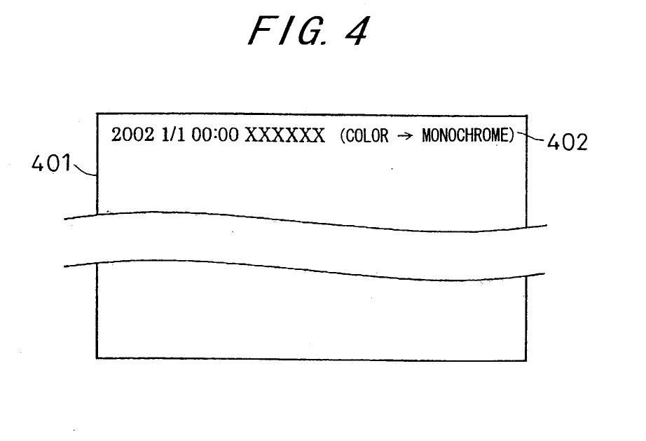

FIG. 4 is a view showing an example of the original document to which the transmitting header in the embodiment of the invention is added. As shown in FIG. 4, the transmitting header 402 is added to the transmitting original document 401 and the message indicating that the color original document was converted to the monochrome original document, namely, “COLOR→MONOCHROME”, is added to the transmitting header 402. The image data to which the transmitting header is added and which is coded are transmitted from the communication control portion 109 to the facsimile apparatus on the receiving side.

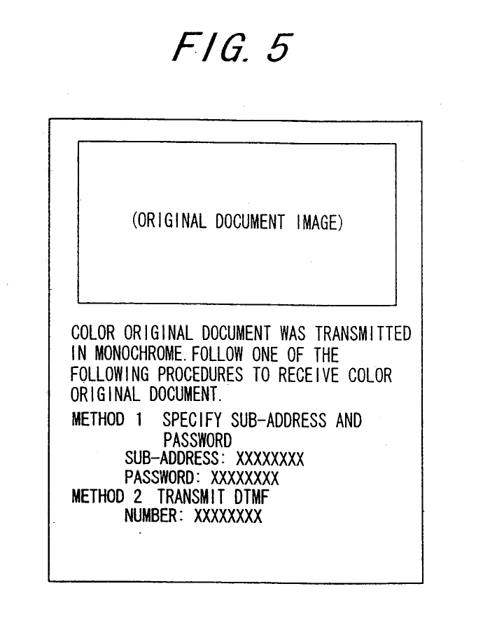

FIG. 5 is a view showing an example of transmitting the contents of the cover page related to the embodiment of the invention with the original document image. In the example shown in FIG. 3, the cover page 301 includes information about a message indicating 305 that the color original document was transmitted in monochrome and for prompting the receiver to re-receive the color original document, the sub-address 306, the password 307 and the DTMF number 308, but instead of this cover page, as shown in FIG. 5, the information may be synthesized with the original document image so as to transmit the information synthesized with the original document image to the facsimile apparatus on the receiving side.

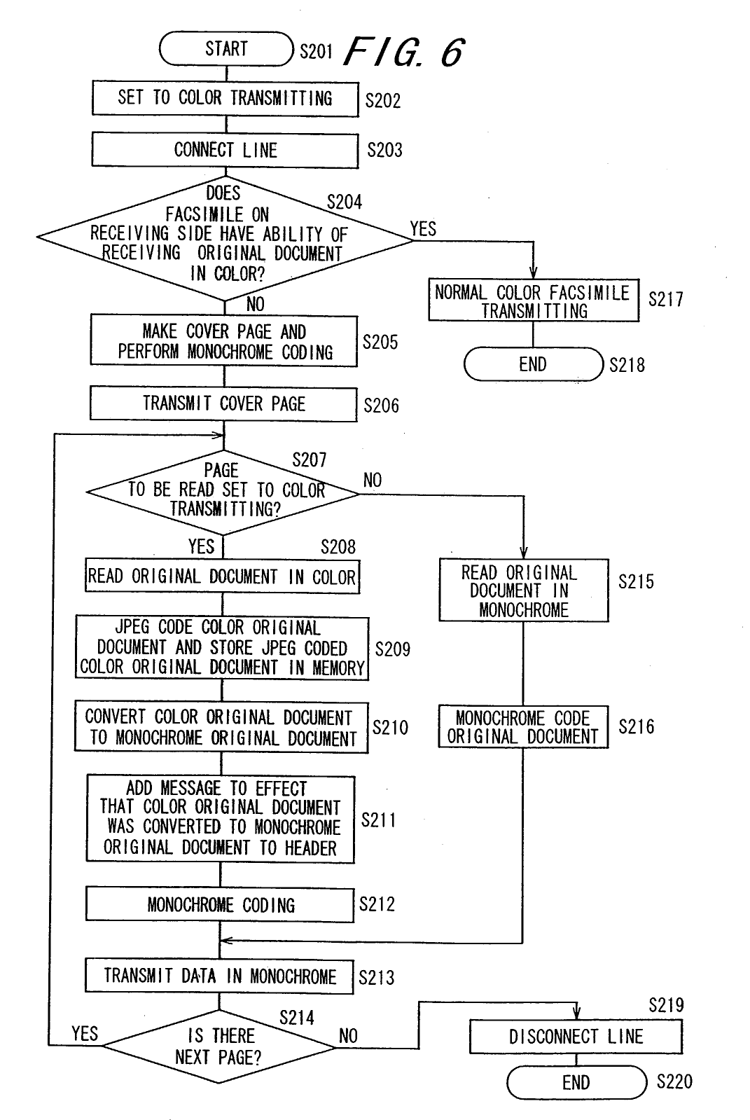

FIG. 6 is a flowchart showing a facsimile transmitting procedure in the facsimile apparatus of the invention.

At step S201, transmitting operation is started. At step S202, the user sets the original document and performs setting for transmitting the original document in color via the operation portion 102 and the display portion 103. At that time, transmitting the all pages of the original document in color or transmitting the original document so as to be switched between color transmitting and monochrome transmitting for each page can be also set. At step S203, the user inputs dial numbers via the operation portion 102 and the display portion 103 and the communication control portion 109 performs connection to the facsimile apparatus on the receiving side in accordance with an instruction from the control portion 101. At step S204, the communication control portion 109 refers to the DIS which was received from the facsimile apparatus on the receiving side and checks whether or not the facsimile apparatus on the receiving side has the ability of receiving the original document in color. When the facsimile apparatus on the receiving side has the ability of receiving the original document in color, the procedure proceeds to step S217 and transmission of the original document is performed in color as usual by the original document reading portion 115 and transmission of the original document is terminated at step S218.

At step S204, when the facsimile apparatus on the transmitting side judges that the facsimile apparatus on the receiving side has no ability of receiving the original document in color, the procedure proceeds to step S205 and the monochrome conversion information adding processing portion 113 makes the cover page describing the message indicating that the color original document was transmitted in monochrome and also describing the sub-address, the password and the DTMF number for retransmitting processing, and the monochrome coding portion 112 codes the cover page in monochrome. At step S206, the communication control portion 109 transmits the cover page coded in monochrome to the facsimile apparatus on the receiving side.

At step S207, the control portion 101 judges whether or not the page to be read is a page set so as to be transmitted in color. When the page to be read is a page set so as to be transmitted in monochrome, the procedure proceeds to step S215 and the original document is read in monochrome. At step S216, the original document is monochrome-coded and thereafter the procedure proceeds to step S213.

At step S207, when the page to be read is a page set so as to be transmitted in color, the procedure proceeds to step S208 and the original document is read in color. At step S209, the read original document is JPEG-coded and the JPEG coded original document is stored in memory, and at step S210, the color original document is converted to the monochrome original document. At step S211, the control portion 101 adds the message, which is made by the monochrome conversion information adding processing portion 113, indicating that the color original document was converted to the monochrome original document, to the transmitting header, and at step S212, the monochrome coding portion 112 codes the transmitting header in monochrome. At step S213, the data monochrome-coded are transmitted to the facsimile apparatus on the receiving side.

At step S214, the control portion 101 judges whether there is a next page to be transmitted or not. When there is the next page to be transmitted, the procedure proceeds to step S207 and the processing from step S207 to step S214 is repeated. At step S214, when the control portion 101 judges that there is not the next page to be transmitted, the procedure proceeds to step S219 and the communication control portion 109 performs processing of disconnecting the line to the facsimile apparatus on the receiving in accordance with the instruction from the control portion 101 and then at step S220, the communication control portion 109 terminates the transmitting operation.

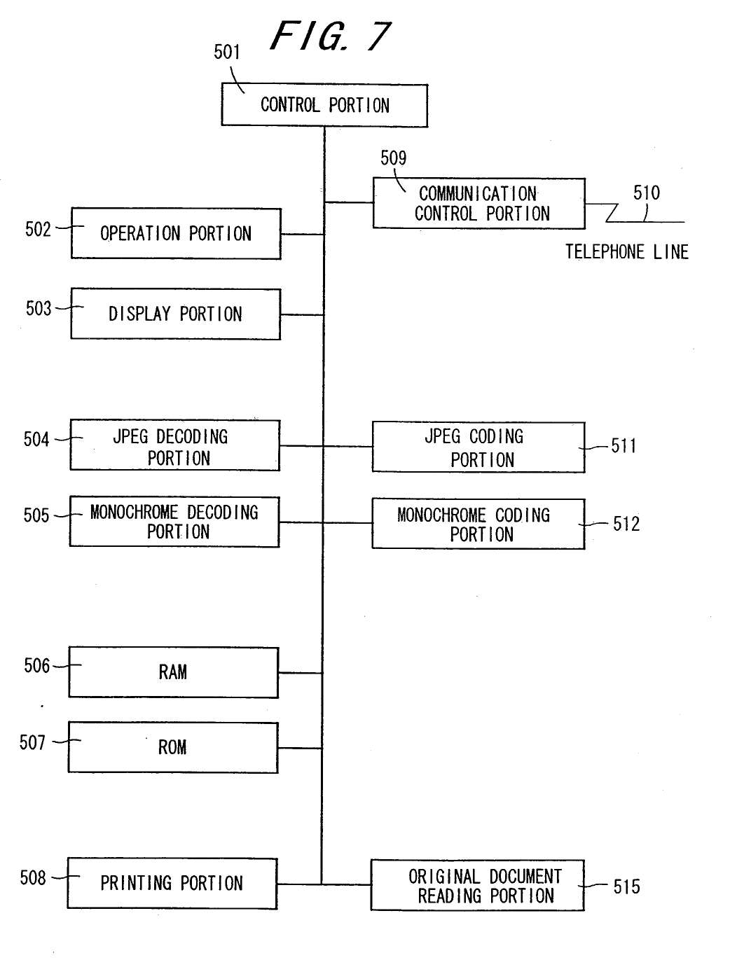

Next, the procedure of re-receiving the color original document by the facsimile apparatus on the receiving side is described. FIG. 7 is a block diagram showing the facsimile apparatus on the receiving side. The facsimile apparatus on the receiving side has the similar configuration as the facsimile apparatus shown in FIG. 1. The facsimile apparatus on the receiving side comprises a control portion 501, an operation portion 502, a display portion 503, a JPEG decoding portion 504, a monochrome decoding portion 505, a RAM 506, a ROM 507, a printing portion 508, a communication control portion 509, a JPEG coding portion 511, a monochrome coding portion 512 and an original document reading portion 515. The facsimile apparatus on the receiving side shown in FIG. 7 has components common to the facsimile apparatus shown in FIG. 1 and description about the components is omitted.

When the facsimile apparatus on the receiving side receives the cover page indicating that the color original document was received in monochrome as shown in FIG. 3, the user refers to the transmitting header of each received page and judges which page was tried to be transmitted in color, and when there is necessity of re-receiving the color original document in color, the user performs re-receiving operation according to the procedure described on the cover page.

Since the facsimile apparatus on the receiving side is under the condition under which color receiving cannot be performed for any reason, it is required that, at first, the reason is eliminated and the facsimile apparatus on the receiving side is made placed in the condition where color receiving can be performed. For example, the following operations are required: Changing ink in the case of exhausted ink; and deleting or printing data accumulated in memory in the case of the shortage of the memory or the like.

When the facsimile apparatus on the receiving side has the function for specifying the sub-address and the password, the user inputs the sub-address and the password described on the received cover page by using an operation portion 502 and performs setting for polling receiving. And then the facsimile apparatus on the receiving side is connected to the facsimile apparatus on the transmitting side via a telephone line 510 by using the communication control portion 509.

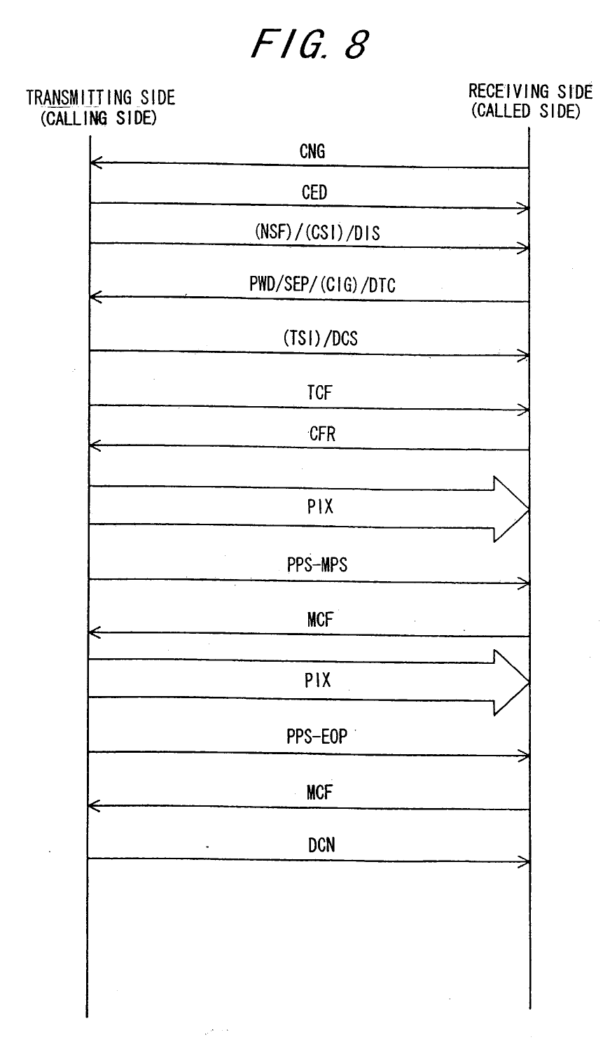

FIG. 8 is a sequence diagram for facsimile procedure signals transmitted/received between the facsimile apparatuses on the transmitting side and the receiving side on the occasion of re-receiving the color original document using the sub-address. The facsimile apparatus on the transmitting side accepts the arrival data transmitted from the facsimile apparatus on the receiving side and returns the CED (Called station identification) for the CNG (Calling tone) transmitted from the facsimile apparatus on the receiving side and transmits the DIS (Digital Information Signal). Here, when there is a color original document to be retransmitted in the facsimile apparatus on the transmitting side, a bit 9 (Completion of preparation for transmitting facsimile document), a bit 47 (Ability of selecting polling) and a bit 49 (Ability of sub-address) of the DIS are set to 1. The NSF (Non-Standard Facilities) and the CSI (Calling Subscriber Identification) are transmitted according to need.

The facsimile apparatus on the receiving side refers to the received DIS and confirms that the bit 9, the bit 47 and the bit 49 of the DIS are set, and then transmits the PWB (Password), the SEP (Selecting Polling) and the DTC (Digital Transmit Command) Here, the input sub-address is included in the SEP and the input password is included in the PWB. In addition, a bit 47 (Ability of selecting polling), a bit 68 (corresponding to JPEG coding) and a bit 69 (corresponding to full color mode) of the DTC are set to 1. A CIG (Calling Subscriber Identification) is transmitted according to need.

The facsimile apparatus on the transmitting side refers to the received DTC and judges that the facsimile apparatus on the receiving side received a request for polling receiving, and the facsimile apparatus on the transmitting side retrieves whether or not data corresponding to the specified sub-address and password exist in the RAM 106 by using the received SEP and PWB. When data corresponding to the specified sub-address and password exist in the RAM 106, the DCS (Digital Command Signal) is transmitted. The TSI (Transmitting Subscriber Identification) is transmitted according to need. When the TCF (Training Check Facilities) signal is transmitted from the facsimile apparatus on the transmitting side and when the facsimile apparatus on the receiving side succeeds in training, the CFR (Confirmation to Receive) is returned. And then the facsimile apparatus on the transmitting side retrieves the color image data from the RAM 106 and transmits the image data (PIX) to the facsimile apparatus on the receiving side via the communication control portion 509. The facsimile apparatus on the receiving side decodes the received image data by the JPEG decoding portion 504 and prints the received image data by the printing portion 508.

When there is the next page to be transmitted after completion of transmitting the image data corresponding to one page, the facsimile apparatus on the transmitting side transmits the PPS-MPS (Partial Page Signal-Multi-Page Signal), and the facsimile apparatus on the receiving side returns the MCF (Message Confirmation) as a response to the PPS-MPS in the case of no existence of an error in the received data, and the facsimile apparatus on the transmitting side transmits the image data (PIX). When there is not the next page to be transmitted, the facsimile apparatus on the transmitting side transmits PPS-EOP (Partial Page Signal-End Of Procedure) and receives the MCF (Message Confirmation) from the facsimile apparatus on the receiving side and then transmits the DCN (Disconnect) and disconnects the line.

Next, description is given about a case where the facsimile apparatus on the receiving side has no function for specifying the sub-address and the password. When the facsimile apparatus on the receiving side has no function for specifying the sub-address and the password, the facsimile apparatus on the receiving side performs the processing of re-receiving by using the DTMF signal. The user performs setting of polling receiving in the facsimile apparatus on the receiving side by using the operation portion 502, and then the facsimile apparatus on the receiving side connects to the facsimile apparatus on the transmitting side via the telephone line 510 by using the communication control portion 509.

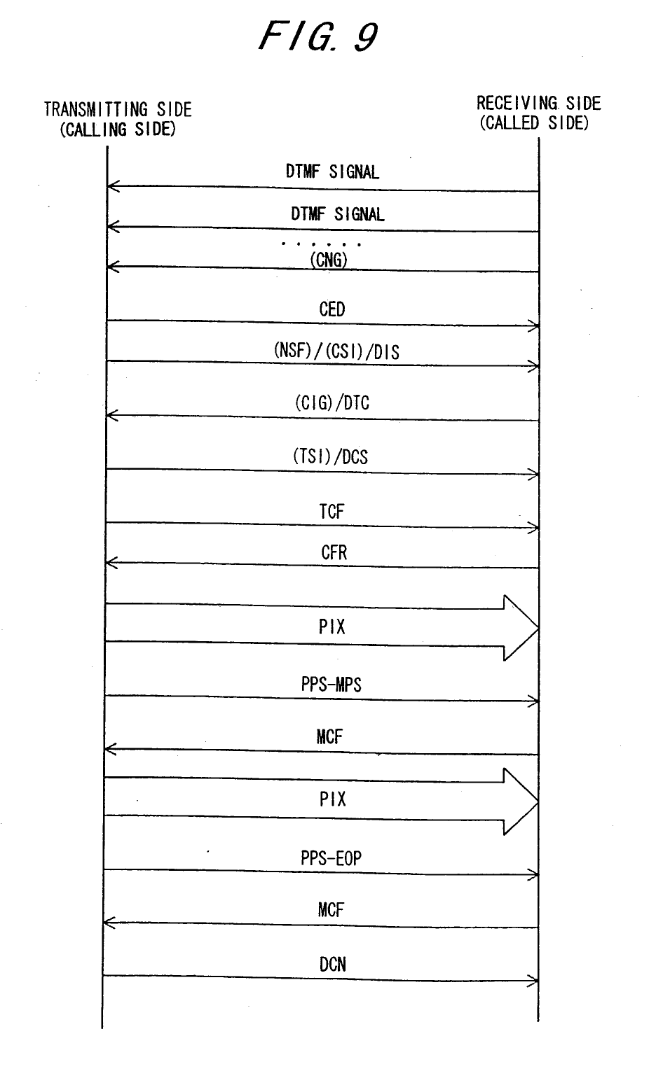

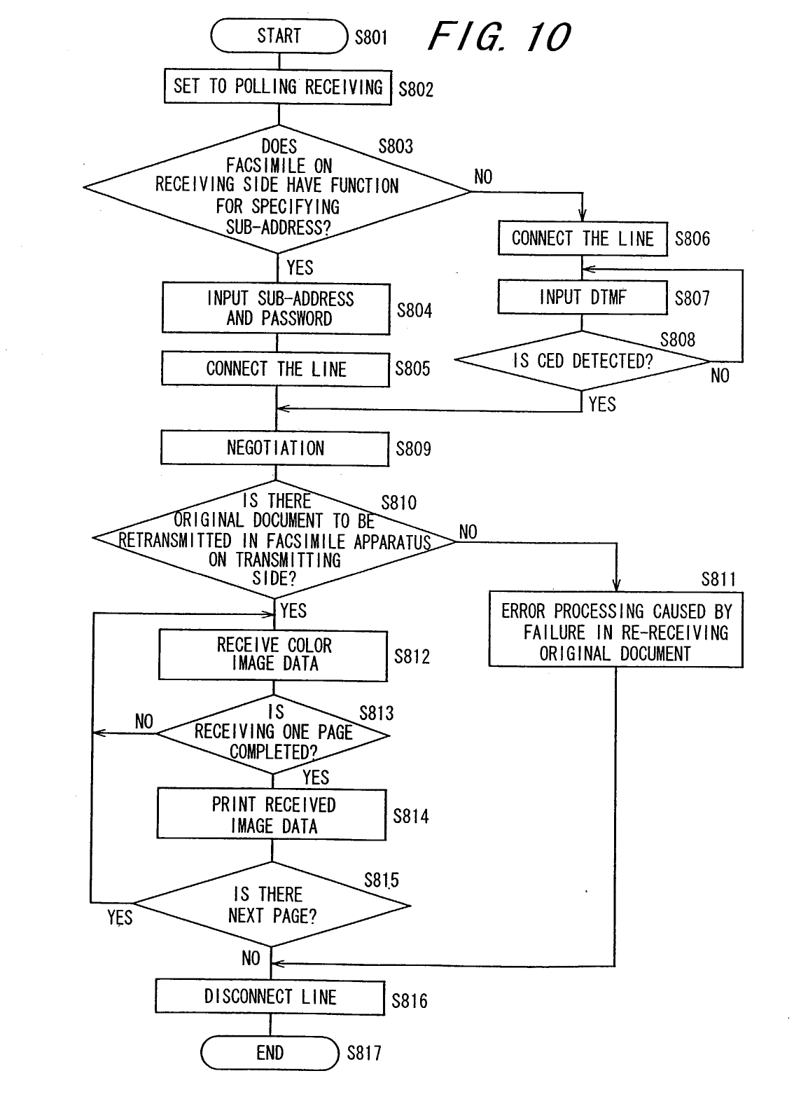

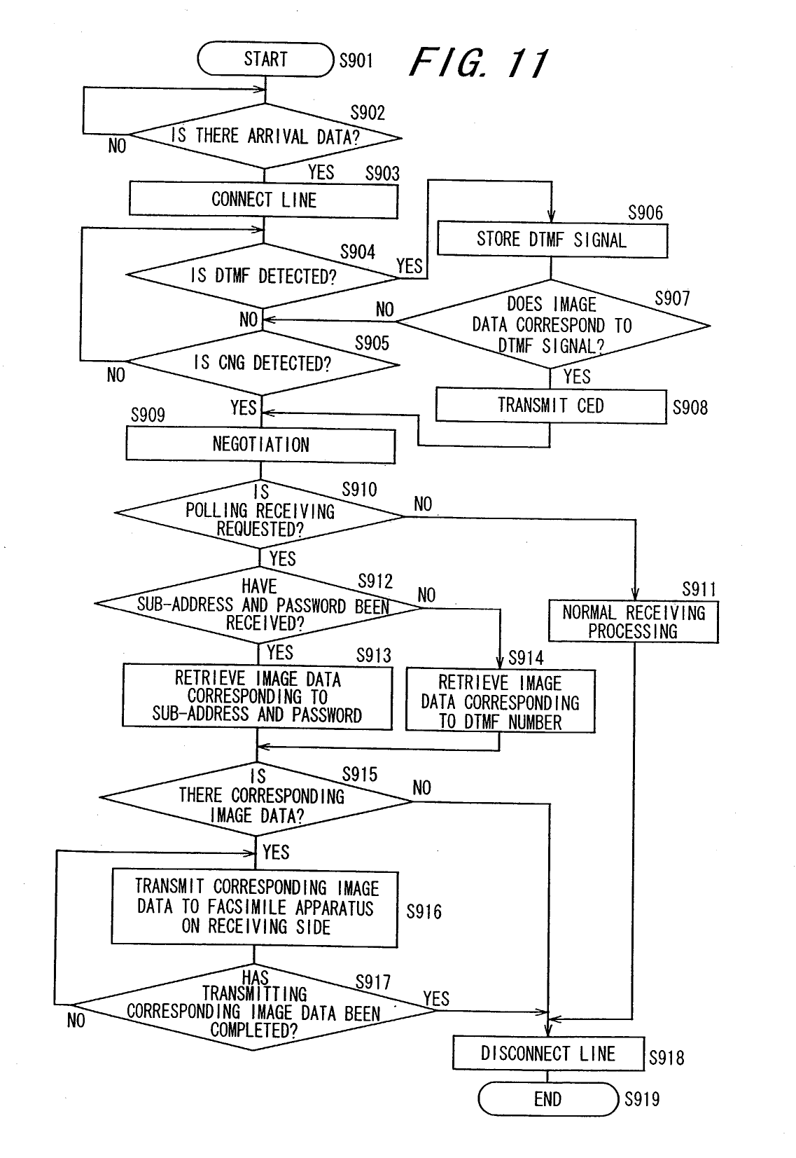

FIG. 9 is a sequence diagram for facsimile procedure signals transmitted/received between the facsimile apparatuses on the transmitting side and the receiving side on the occasion of re-receiving the color original document by using the DTMF signal. Details about the sequence are described in after-mentioned FIGS. 10 and 11. The facsimile apparatus on the transmitting side accepts the arrival data transmitted from the facsimile apparatus on the receiving side and waits for the DTMF signal or the CNG signal to be transmitted. The user inputs the DTMF number described on the cover page by using the operation portion 502 of the facsimile apparatus on the receiving side. As to the CNG, the CNG is used for making the end of the DTMF signal identify and is not transmitted in the case of no need of the CNG.

When the facsimile apparatus on the transmitting side receives the DTMF signal, the facsimile apparatus on the transmitting side stores the received DTMF signal and retrieves whether or not the image data corresponding to a DTMF number given from combination of the stored DTMF signal and subsequently received DTMF signal exist in the RAM 106. When corresponding image data exist, the facsimile apparatus on the transmitting side transmits the CED signal and subsequently transmits the DIS. Here, the bit 9 (Completion of preparation for transmitting facsimile document) of the DIS is set. The NSF (Non-Standard Facilities) and the CSI (Calling Subscriber Identification) are transmitted according to need.

The facsimile apparatus on the receiving side refers to the received DIS and confirms that the bit 9 is set and then transmits the DTC (Digital Transmit Command). Here, the bit 68 (corresponding to JPEG coding) and the bit 69 (corresponding to full color mode) of the DTC are set to 1. The CIG (Calling Subscriber Identification) is transmitted according to need. The facsimile apparatus on the transmitting side refers to the received DTC and judges that the facsimile apparatus on the receiving side received the request for polling receiving and the DCS (Digital Command Signal) is transmitted. The TSI (Transmitting Subscriber Identification) is transmitted according to need.

When the TCF (Training Check Facilities) signal is transmitted from the facsimile apparatus on the transmitting side and the facsimile apparatus on the receiving side succeeds in training, the CFR (Confirmation to Receive) is returned. And then the facsimile apparatus on the transmitting side retrieves the color image data from the RAM 106 and transmits the image data (PIX) to the facsimile apparatus on the receiving side via the communication control portion 509. The received image data are decoded by the JPEG decoding portion 504 and printing the received image data is performed by the printing portion 508.

When there is the next page to be transmitted after completion of transmitting the image data corresponding to one page, the facsimile apparatus on the transmitting side transmits the PPS-MPS (Partial Page Signal-Multi-Page Signal), and the facsimile apparatus on the receiving side returns the MCF (Message Confirmation) as the response to the PPS-MPS in the case of no existence of an error in the received data and the facsimile apparatus on the transmitting side transmits the image data (PIX) When there is not the next page to be transmitted, the facsimile apparatus on the transmitting side transmits PPS-EOP (Partial Page Signal-End Of Procedure) and receives the MCF (Message Confirmation) from the facsimile apparatus on the receiving side and transmits the DCN (Disconnect) and disconnects the line.

FIG. 10 is a flowchart showing a re-receiving procedure of the facsimile apparatus on the receiving side. At step S801, the re-receiving operation is started. At step S802, the user performs setting for performance of polling receiving via the operation portion 502 and the display portion 503. At step S803, according to presence or absence of the function for specifying the sub-address in the facsimile apparatus on the receiving side, when the facsimile apparatus on the receiving side has the function for specifying the sub-address, the procedure proceeds to step S804, whereas when the facsimile apparatus on the receiving side does not have the function for specifying the sub-address, the procedure proceeds to step S806.

When the facsimile apparatus on the receiving side has the function for specifying the sub-address, at step S804, the sub-address and the password are input by the user, and at step S805, the line is connected to the facsimile apparatus on the transmitting side by the user's dial input.

On the other hand, when the facsimile apparatus on the receiving side does not have the function for specifying the sub-address, at step S806, the line is connected to the facsimile apparatus on the transmitting side by the user's dial input. After the line is connected to the facsimile apparatus on the transmitting side, at step S807, input of the DTMF signal is performed. At step S808, the communication control portion 509 identifies whether the CED signal was detected or not, and the procedure proceeds to step S809 by detection of the CED signal or operation of terminating transmitting the DTMF signal.

At step S809, negotiation with the facsimile apparatus on the transmitting side is performed by the communication control portion 509. At step S810, when there is no original document to be retransmitted in the facsimile apparatus on the transmitting side on the basis of the negotiation, the procedure proceeds to step S811 and communication error arises, and at step S816, the communication control portion 509 disconnects the line and at step S817, the re-receiving processing is terminated.

At step S810, when there is the original document to be retransmitted in the facsimile apparatus on the transmitting side, the procedure proceeds to step S812 and the communication control portion 509 receives the color image data. At step S813, the communication control portion 509 identifies completion of receiving one page of the original document. In the case of incompletion of receiving one page of the original document, the procedure returns to step S812 and reception of the color image data is continued. In the case of completion of receiving one page of the original document, the procedure proceeds to step S814 and the printing portion 508 prints the received color image data. At step S815, the communication control portion 509 identifies whether the next page data to be received exists or not. In the case of existence of the next page data, the procedure returns to step S812 and the processing from step S812 to step S815 is repeated. In the case of no existence of the next page data, the procedure proceeds to step S816 and the communication control portion 509 disconnects the line, and at step S817, the communication control portion 509 terminates the re-receiving procedure.

FIG. 11 is a flowchart showing a re-transmitting procedure of the facsimile apparatuses on the transmitting side when the re-receiving operation of the color original document is performed. At step S901, the transmitting procedure is started. At step S902, the communication control portion 109 waits for arrival data and when arrival data are accepted, the procedure proceeds to step S903. At step S903, the communication control portion 109 connects the line to the facsimile apparatus on the receiving side and waits for detection of the DTMF signal or the CNG signal. At step S904, the communication control portion 109 identifies whether the DTMF signal is detected or not. When the DTMF signal is detected, at step S906, the control portion 101 stores the received DTMF signal in the RAM 106.

At step S907, the communication control portion 109 retrieves whether or not image data corresponding to the DTMF number made by lining up DTMF signals stored in order exist in memory, for example the RAM 106. When no corresponding image data exists, the procedure proceeds to step S905. When the corresponding image data exists, the procedure proceeds to step S908. At step S908, the communication control portion 109 transmits the CED signal and the procedure proceeds to step S909.

On the other hand, at step S904, when the DTMF signal is not detected, at step S905, the communication control portion 109 identifies whether the CNG signal is detected or not. When the CNG signal is not detected, the procedure returns to step S904. When the CNG signal is detected, the procedure proceeds to step S909. At step S909, the communication control portion 109 performs negotiation with the facsimile apparatus on the receiving side. At step S910, when the communication control portion 109 judges that the facsimile apparatus on the receiving side requests polling receiving on the basis of the negotiation, the procedure proceeds to step S912. When the facsimile apparatus on the receiving side does not request polling receiving, the procedure proceeds to step S911 and normal facsimile receiving processing is performed. After termination of facsimile receiving, the line is disconnected at step S918, and the retransmitting procedure is terminated at step S919.

At step S912, the communication control portion 109 judges whether or not the sub-address and the password is received on the basis of the negotiation. When the sub-address and the password are received, the procedure proceeds to step S913 and the control portion 101 retrieves the image data corresponding to the sub-address and the password from the memory, for example, the RAM 106. When the sub-address and the password are not received, the procedure proceeds to step S914 and the control portion 101 retrieves image data corresponding to the DTMF number from the memory, for example the RAM 106. At step S915, when the control portion 101 judges that the corresponding image data exists, the procedure proceeds to step S916 and the corresponding image data is retrieved from the memory and the corresponding image data is transmitted to the facsimile apparatus on the receiving side.

At step S917, the communication control portion 109 judges whether transmitting the image data is completed or not, and until transmitting the image data is terminated, the processing from step S916 to step S917 is repeated. When transmission of the image data is completed, at step S918 the communication control portion 109 disconnects the line, and at step S919, the retransmitting procedure is terminated. At step S915 when no corresponding image data exists, at step S918 the communication control portion 109 disconnects the line, and at step S919 the retransmitting procedure is terminated.

After the facsimile apparatus on the transmitting side shown in FIG. 1 terminates the facsimile transmitting procedure described by the flowchart in FIG. 6, for the purpose of retransmission, the facsimile apparatus on the transmitting side stores the color image data in the RAM 106 and also starts to measure a constant time, for example an hour. When there is no request for retransmitting the color image data from the facsimile apparatus on the receiving side even after elapsing of the constant time, the color image data stored in the RAM 106 is deleted. The time required by deletion of the color image data is set by the user in advance by means of the operation portion 102.

In the embodiment of the invention, the method performed by using the sub-address and the password and the method performed by using the DTMF signal are suggested as the re-receiving method, but retransmitting processing may be verbally requested to the transmitter by using the transmitter's number described on the cover page. In addition, the embodiment of the invention describes the color facsimile apparatus, but is not restricted to the color facsimile apparatus and can be applied to an apparatus having a function for transmitting the color image.

As descried above, features of the embodiment of the invention include embodiment having the following configuration, functions and operations.

The facsimile apparatus according to the embodiment of the invention comprises the monochrome conversion portion for converting the color original document to the monochrome original document on the occasion of transmitting the color original document in monochrome, and the monochrome conversion information adding processing portion for adding the message indicating that the color original document was transmitted in monochrome, when the facsimile apparatus tries to transmit the color original document and the other facsimile apparatus declares that the other facsimile one has only ability of receiving the color original document in monochrome. According to such a configuration, even when the color original document was received in monochrome in spite of presence of the other facsimile apparatus ability of receiving the color original document in color in the case of the facsimile apparatus receiving (in other words, even when the other facsimile apparatus declares to the facsimile apparatus on the transmitting side that the other facsimile apparatus can perform only receiving in monochrome because of exhausted ink or shortage of the memory or the like), the user can be aware that the color original document was received in monochrome because the message indicating that the color original document was transmitted in monochrome is transmitted from the facsimile apparatus on the transmitting side. Further, in the facsimile apparatus on the transmitting side, there is similarly occurrence of merits that the facsimile apparatus on the transmitting side can receive request for retransmitting the original document in color from the facsimile apparatus on the receiving side by notifying the facsimile apparatus on the receiving side that the original document is a color original document even if the original document is output in monochrome.

In addition, the facsimile apparatus according to the embodiment of the invention comprises the monochrome conversion information adding processing portion having the function for adding the message indicating that the color original document was transmitted in monochrome to the cover page, and the facsimile apparatus transmits the cover page with added message to the other facsimile one. According to such a configuration, the user on the receiving side refers to the received cover page and can be aware that the original document was tried to be transmitted in color. Furthermore, it is also possible that the procedure of the request for re-receiving the original document is described.

In addition, the facsimile apparatus according to the embodiment of the invention comprises the monochrome conversion information adding processing portion having the function for adding the message indicating that the color original document was transmitted in monochrome to the transmitting header of the color original document, and the facsimile apparatus transmits the original document with the message added to the transmitting header in the case where the original document is one tried to be transmitted in color. According to such a configuration, the facsimile apparatus on the transmitting side can perform switching between transmitting in color and transmitting in monochrome by every page for mixture of color original document and monochrome original document. The user on the receiving side can identify which page was tried to be transmitted in color by addition of the message indicating that the color original document was converted in monochrome to the transmitting header by every page.

In addition, the facsimile apparatus according to the embodiment of the invention stores the original document which was tried to be transmitted in color in the RAM and transmits the message prompting the other facsimile apparatus to re-receive the original document and transmits the color original document stored in the RAM in color when request for re-receiving the original document is transmitted from the other facsimile apparatus. According to such a configuration, when the color original document was transmitted in monochrome and the color original document was stored in the RAM, the color original document stored in the RAM can be transmitted in color when the request for retransmitting the original document is transmitted from the facsimile apparatus on the receiving side.

In addition, the facsimile apparatus according to the embodiment of the invention assigns the sub-address and the password to the original document which was tried to be transmitted in color on the occasion of storing the original document in the RAM and transmits the sub-address and the password described on the cover page. Thereby when the request for receiving the original document by using the sub-address and the password is transmitted from the other facsimile apparatus, the facsimile apparatus according to the embodiment of the invention retrieves the corresponding color original document from the RAM and transmits the original document in color. In this case, the password is effective only in the case where the user sets and the password is not required on minimum configuration element. The color original document stored in the storing portion (RAM) by using such a configuration is managed by the sub-address, and thereby when the request for re-receiving the original document is transmitted from the facsimile apparatus on the receiving side, the facsimile apparatus according to the embodiment of the invention can identify which color original document stored in the RAM is retransmitted by using the specified sub-address.

In addition, the facsimile apparatus according to the embodiment of the invention assigns the DTMF signal to the original document which was tried to be transmitted in color on the occasion of storing the original document in the RAM and transmits the DTMF signal described on the cover page, and thereby when the request for receiving the original document by using the DTMF signal is transmitted from the other facsimile apparatus, the facsimile apparatus according to the embodiment of the invention retrieves the corresponding color original document from the RAM and transmits the original document in color. According to such a configuration, even when the facsimile apparatus on the receiving side cannot use the sub-address and the password, re-receiving the color original document can be performed with use of the DTMF signal.

In addition, the facsimile apparatus according to the embodiment of the invention stores the original document which was tried to be transmitted in color in RAM, and when the request for receiving the original document is not transmitted from the other facsimile apparatus after a specified time has elapsed, the color original document stored in the RAM is deleted. According to such a configuration, even when the request for receiving the original document is not transmitted because of the case where the facsimile apparatus on the receiving side really has no ability of receiving the original document in color or it is judged on the receiving side that there is no need for receiving the original document in color, the color original document to be used for retransmitting is deleted from the RAM after the specified time has elapsed, and thereby a space of RAM emptied by deletion of the color original document to be used for retransmitting can be re-utilized.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A color image transmitting apparatus having a color image communication function, comprising:
a communication control portion having a function judging whether an apparatus on other side has an ability of receiving a color image or not;
a monochrome conversion portion for converting the color image to a monochrome image according to judgment of the ability of receiving the color image; and
a monochrome conversion information adding processing portion for adding a message indicating that the color image was transmitted as a monochrome image.

2. The color image transmitting apparatus of claim 1, wherein the monochrome conversion information adding processing portion has a function for making a cover page with the added message indicating that the color image was transmitted as the monochrome image.

3. The color image transmitting apparatus of claim 1, wherein the monochrome conversion information adding processing portion has a function for making a transmitting header with the added message indicating that the color image was transmitted as the monochrome image.

4. The color image transmitting apparatus of claim 3, wherein the transmitting header is provided on each page of the transmitting image.

5. The color image transmitting apparatus of claim 1, wherein the monochrome conversion information adding processing portion has a function of adding a message indicating that the color image was transmitted in monochrome to the image to be transmitted.

6. The color image transmitting apparatus of claim 1, further comprising a storage portion for storing temporarily the color image when the color image was transmitted as the monochrome image.

7. The color image transmitting apparatus of claim 1, wherein the message includes a sub-address for prompting the apparatus on the other side to re-receive the color image.

8. The color image transmitting apparatus of claim 1, wherein the message includes a DTMF signal for prompting the apparatus on the other side to re-receive the color image.

9. The color image transmitting apparatus of claim 6, wherein when there is no request for re-receiving in spite of elapsing of a certain time at a time of storing the color original document in the storage portion, the stored color original document is deleted.
